(19) United States
(12) Patent Application Publication
(10) Pub. No.: US 2026/0342187 A1
(43) Pub. Date: Oct. 29, 2026

(54) Tri-Rotor Generator

(71) Applicant: Raymond A. Suda, Sterling Heights, MI (US)

(72) Inventor: Raymond A. Suda, Sterling Heights, MI (US)

(21) Appl. No.: 19/327,407

(22) Filed: Sep. 12, 2025

Related U.S. Application Data
(60) Provisional application No. 63/796,671, filed on Apr. 29, 2025.

(51) Int. Cl. H02K 16/00; H02K 7/116

(52) U.S. Cl. CPC H02K 16/005; H02K 7/116

(57) ABSTRACT

A tri-rotor generator includes a first magnetic rotor, a second magnetic rotor, and a coil rotor. The first magnetic rotor includes one or more magnetic field sources. The second magnetic rotor includes one or more magnetic field sources. The coil rotor includes one or more electrical coils. The coil rotor may be disposed between the first magnetic rotor and the second magnetic rotor. The first magnetic rotor and the second magnetic rotor may be rotated in a first direction, and the coil rotor may be rotated in a second, opposite direction.

### CROSS-REFERENCE TO RELATED APPLICATION(S)

This application claims priority to and the benefit of U.S. Provisional Patent Application Ser. No. 63/796,671, filed Apr. 29, 2025, the entire disclosure of which is hereby incorporated by reference.

### TECHNICAL FIELD

This disclosure relates to electric generators, specifically, a tri-rotor generator with counter rotating rotors.

### BACKGROUND

Electric generators convert mechanical energy into electrical energy through the principle of electromagnetic induction. According to Faraday's Law, an electromotive force (emf) is induced in a conductor when the magnetic flux through the conductor changes over time, expressed mathematically as emf=−dΦ_{B}/dt, where Φ_{B} is the magnetic flux. In practical applications, this is often achieved by rotating magnets near coils of wire, or vice versa, which causes the magnetic field through the coils to vary. This changing magnetic field induces a current in the wire, thereby generating electricity.

In traditional electric generators, the conversion of mechanical to electrical energy involves a rotor and a stator. The rotor, which is mechanically driven, contains either permanent magnets or electromagnets and rotates within or around the stator. The stator is composed of coils of conductive wire, usually copper, arranged to form a stationary magnetic circuit. As the rotor spins, its magnetic field sweeps across the coils, causing a continuous change in magnetic flux through the coils, which induces an alternating current (AC) in the coils.

### SUMMARY

A first aspect of the disclosed implementations is a generator, including a first magnetic rotor including one or more magnetic field sources, a second magnetic rotor including one or more magnetic field sources, and a coil rotor including one or more electrical coils, wherein the coil rotor is disposed between the first magnetic rotor and the second magnetic rotor.

In some aspects, the generator further includes a shaft, wherein the first magnetic rotor and the second magnetic rotor are rotationally connected to the shaft.

In some aspects, each of the one or more magnetic field sources is a permanent magnet or an electromagnet.

In some aspects, the first magnetic rotor, the second magnetic rotor, and the coil rotor are rotationally connected to a motor through a gear box.

In some aspects, the gear box is a planetary gear assembly, the planetary gear assembly including a sun gear rotationally connected to the first magnetic rotor and the second magnetic rotor, and a ring gear rotationally connected to the coil rotor.

In some aspects, the generator further includes a first shaft rotationally connected to the sun gear, wherein rotation of the first shaft causes the first magnetic rotor and the second magnetic rotor to rotate in a first direction and causes the coil rotor to rotate in a second direction; and a second shaft rotationally connected to a planet carrier of the planetary gear assembly.

In some aspects, the one or more electrical coils include four coils associated with a first phase and four coils associated with a second phase, the four coils associated with the first phase are connected in series and terminate in a first wire and a second wire, and the four coils associated with the second phase are connected in series and terminate in a third wire and a fourth wire.

In some aspects, the generator further includes a first brush electrically connected to the first wire, a second brush electrically connected to the second wire, a third brush electrically connected to the third wire, and a fourth brush electrically connected to the fourth wire.

A second aspect of the disclosed implementations is a generator, including a first magnetic rotor rotationally connected to a sun gear of a planetary gear assembly, a second magnetic rotor rotationally connected to the sun gear, a coil rotor rotationally connected to a ring gear of the planetary gear assembly, wherein the coil rotor is disposed between the first magnetic rotor and the second magnetic rotor, and a first shaft rotationally connected to the ring gear, wherein rotation of the first shaft causes the ring gear and the coil rotor to rotate in a first direction and causes the sun gear, the first magnetic rotor, and the second magnetic rotor to rotate in a second direction.

In some aspects, the generator further includes a second shaft rotationally connected to a planet carrier of the planetary gear assembly, and a motor rotationally connected to the second shaft.

In some aspects, the motor is configured to control rotation of the sun gear and the ring gear to maintain a constant electrical output frequency.

In some aspects, the motor is configured to rotate the second shaft in response to changes in rotation of the first shaft.

In some aspects, the first magnetic rotor, the second magnetic rotor, and the coil rotor are arranged in an axial direction of the first shaft.

A third aspect of the disclosed implementations is a generator, including an inner rotor rotationally connected to a shaft, a middle rotor including two or more coils, wherein a first portion of the middle rotor at least partially surrounds at least a portion of the inner rotor and a second portion of the middle rotor extends beyond the inner rotor in an axial direction, and an outer rotor, wherein the outer rotor at least partially surrounds the first portion of the middle rotor, and the outer rotor and the inner rotor each include one or more magnetic field sources.

In some aspects, the outer rotor is rotationally connected to the shaft.

In some aspects, the outer rotor is rotationally connected to the inner rotor such that the outer rotor rotates synchronically and in a same direction as the inner rotor.

In some aspects, the middle rotor is rotationally connected to at least one gear rotationally connected to the shaft.

In some aspects, the inner rotor, the middle rotor, and the outer rotor are rotationally connected to a motor through a gear box.

In some aspects, the gear box includes a full mode wherein the inner rotor, the middle rotor, and the outer rotor are rotationally connected to the motor and a reduced mode wherein one or more of the inner rotor, the middle rotor, and the outer rotor are not rotationally connected to the motor.

In some aspects, the two or more coils are electrically connected to brushes on the second portion of the middle rotor.

These aspects and other implementations and variations in the aspects are described in additional detail below.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a first view of a radial configuration of a tri-rotor generator.

FIG. 2 is a second view of the tri-rotor generator of FIG. 1.

FIG. 3 is a third view of the tri-rotor generator of FIG. 1.

FIG. 4 is an exploded view of the tri-rotor generator of FIG. 1.

FIG. 5 is the tri-rotor generator of FIG. 1 including a gear box.

FIGS. 6A and 6B are exploded views of the tri-rotor generator of FIG. 1 including the gear box.

FIG. 7 is a first view of an axial configuration of the tri-rotor generator.

FIG. 8 is an exploded view of the tri-rotor generator of FIG. 7.

FIG. 9 is the tri-rotor generator of FIG. 7 including a planetary gear assembly.

FIG. 10 is an exploded view of the tri-rotor generator of FIG. 7 including the planetary gear assembly.

### DETAILED DESCRIPTION

Faraday's Law provides that the electromotive force produced in a coil of wire is equal to the rate of change of the magnetic flux. Increasing the rate of change of the magnetic flux will increase the voltage produced in the coil of wire. The rate of change of the magnetic flux may be increased by increasing the rotational speed of the magnets with respect to the coils of wire. In a traditional electric generator, increasing the rotational speed of the magnets with respect to the coils of wire would require increasing the rotational speed of the rotor with respect to the stator.

The power produced by the generator is equal to the voltage (V) squared, divided by the resistance (R) of the coils of wire. The resistance of the coils of wire remains constant. Thus, increasing the voltage produced in the coil of wire will increase the power produced by the generator. It may be desirable to increase the power produced by the generator without increasing the mass of the generator.

Accordingly, a tri-rotor generator is described. The tri-rotor generator includes a first rotor containing either permanent magnets or electromagnets (e.g., a first magnetic rotor), a second rotor containing the coils of wire (e.g., a coil rotor), and a third rotor containing either permanent magnets or electromagnets (e.g., a second magnetic rotor). By rotating the magnets past the coils of wire (e.g., rotating the first rotor and the third rotor in a clockwise direction) while simultaneously rotating the coils of wire in an opposite direction (e.g., rotating the second rotor in a counterclockwise direction), the rotational speed of the magnets with respect to the coils of wire can be increased. Thus, the tri-rotor generator may increase the rate of change of the magnetic flux without increasing mass. The tri-rotor generator may produce more power than a traditional generator of the same mass.

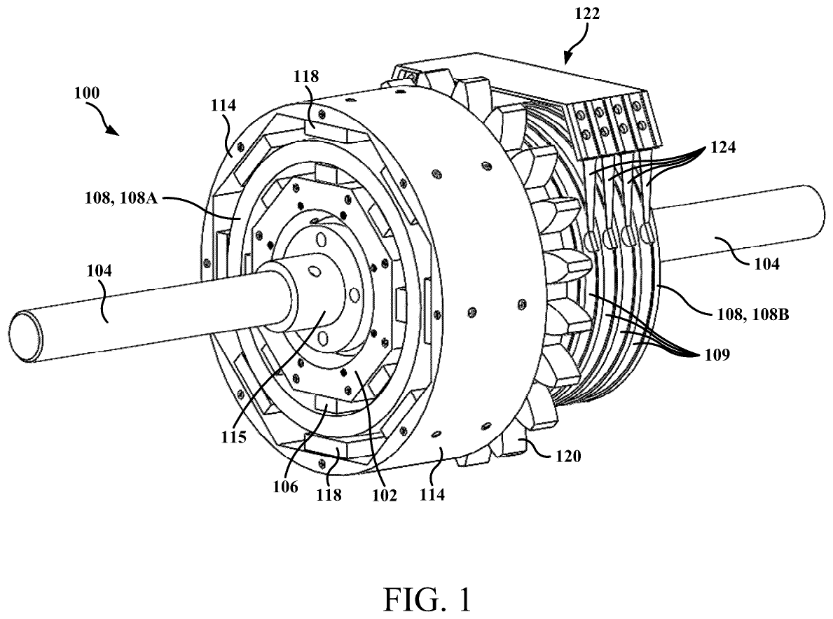

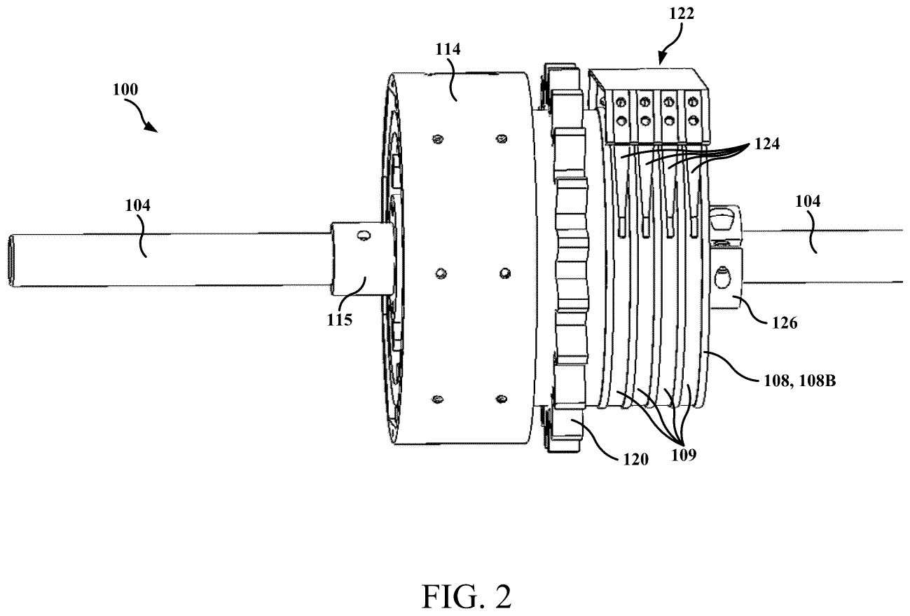

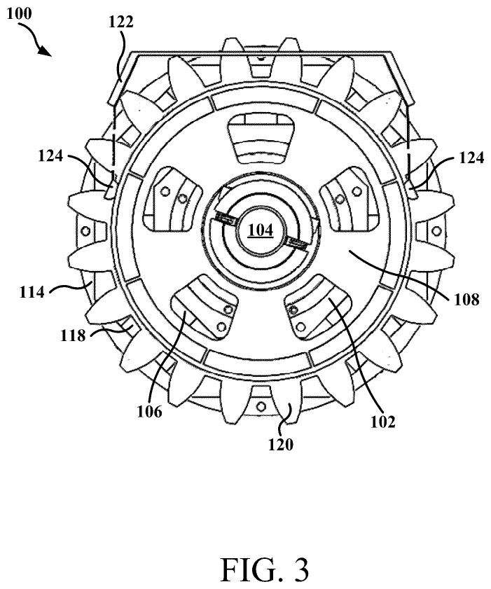

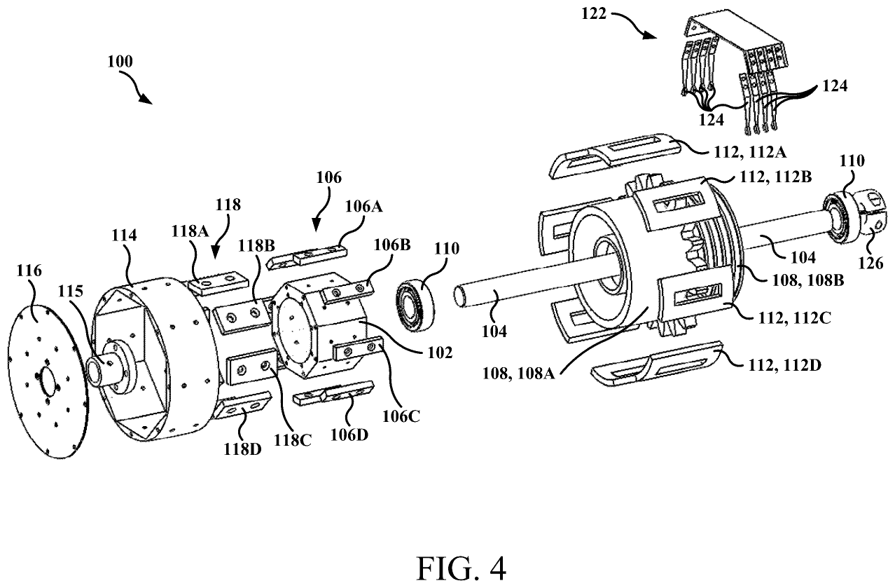

Referring to FIGS. 1 to 4, a first implementation (e.g., a radial configuration) of a tri-rotor generator 100 is shown. The tri-rotor generator 100 may include a case (e.g., a housing, container, cover, or the like) containing components of the tri-rotor generator 100. For ease of understanding, the case is omitted from FIGS. 1 to 4. The tri-rotor generator 100 may include a first magnetic rotor 102 rotationally connected to a shaft 104. In the first implementation of the tri-rotor generator 100, the first magnetic rotor 102 may be, for example, an inner rotor. The first magnetic rotor 102 may be rotated by the shaft 104, that is, a rotational force applied to the shaft 104 may drive the first magnetic rotor 102. Rotational force may be applied to the shaft 104 using, for example, a first motor. The first magnetic rotor 102 may be made from metal, for example, steel. The first magnetic rotor 102 may include one or more inner magnets 106. The inner magnets 106 may be located on an outer surface of the first magnetic rotor 102. The inner magnets 106 may be magnetic field sources. For example, the inner magnets 106 may be permanent magnets. In another example, the inner magnets 106 may be electromagnets. The inner magnets 106 may be arranged to alternate polarity around the first magnetic rotor 102. For example, a first inner magnet 106A may be a first polarity, a second inner magnet 106B may be a second polarity, a third inner magnet 106C may be the first polarity, and a fourth inner magnet 106D may be the second polarity.

The tri-rotor generator 100 may include a coil rotor 108. In the first implementation of the tri-rotor generator 100, the coil rotor 108 may be, for example, a middle rotor. The coil rotor 108 may be made from, for example, plastic or metal (e.g., stamped metal pieces). The coil rotor 108 may be configured to rotate independently from the shaft 104. For example, the coil rotor 108 may include one or more bearings 110 such that the coil rotor 108 may rotate freely (e.g., independently) with respect to the shaft 104.

In the first implementation of the tri-rotor generator 100, the coil rotor 108 may include a first portion 108A of the coil rotor 108 and a second portion 108B of the coil rotor 108. The first portion 108A may include one or more coils 112. In an example, there may be eight coils 112. The coils 112 may be coils of conductive wire (e.g., copper) in which an electric current may be induced. For example, the coils 112 may be enclosed in the first portion 108A. The first portion 108A may at least partially surround the first magnetic rotor 102. The first portion 108A may surround the first magnetic rotor 102 such that the coils 112 intersect the magnetic field generated by the inner magnets 106.

The second portion 108B may extend beyond the first magnetic rotor 102 in an axial direction (e.g., along the shaft 104). The second portion 108B may include wires connected to the coils 112. The wires may electrically connect the coils 112 to conductive rings 109 around the second portion 108B. In an example, there may be eight coils 112 connected to four conductive rings 109 around the second portion 108B, that is, two conductive rings 109 may be electrically connected to four of the eight coils 112 and the other two conductive rings 109 may be connected to the other four of the eight coils 112.

The tri-rotor generator 100 may include a second magnetic rotor 114. In the first implementation of the tri-rotor generator 100, the second magnetic rotor 114 may be, for example, an outer rotor. The second magnetic rotor 114 may at least partially surround the first portion 108A of the coil rotor 108. In the first implementation of the tri-rotor generator 100, the first magnetic rotor 102, the coil rotor 108, and the second magnetic rotor 114 may be arranged in a radial direction extending perpendicular to an axial direction of the shaft 104.

The second magnetic rotor 114 may be made from metal, for example, steel. The second magnetic rotor 114 may be configured to rotate with the first magnetic rotor 102. The second magnetic rotor 114 may be rotationally connected to the shaft 104. Alternatively, the second magnetic rotor 114 may be rotationally connected to the first magnetic rotor 102. For example, the second magnetic rotor 114 may be connected to the shaft 104 using shaft collar 115 and a side plate 116. The shaft collar 115 may be rotationally connected to the shaft 104. The side plate 116 may be connected to the second magnetic rotor 114 and the shaft collar 115. The second magnetic rotor 114 and the first magnetic rotor 102 may be configured to rotate synchronically and in a same direction.

The second magnetic rotor 114 may include one or more outer magnets 118. The outer magnets 118 may be located on an inner surface of the second magnetic rotor 114. The outer magnets 118 may be magnetic field sources. For example, the outer magnets 118 may be permanent magnets. In another example, the outer magnets 118 may be electromagnets. The second magnetic rotor 114 may surround the first portion 108A of the coil rotor 108 such that the coils 112 intersect the magnetic field generated by the outer magnets 118. The outer magnets 118 may be arranged to alternate polarity around the second magnetic rotor 114. For example, a first outer magnet 118A may be a first polarity, a second outer magnet 118B may be a second polarity, a third outer magnet 118C may be the first polarity, and a fourth outer magnet 118D may be the second polarity.

The first magnetic rotor 102 and the second magnetic rotor 114 may be configured to rotate synchronously and in a first direction, and the coil rotor 108 may be configured to rotate in a second direction opposite the first direction. For example, the first magnetic rotor 102 and the second magnetic rotor 114 may be configured to rotate in a clockwise direction, and the coil rotor 108 may be configured to rotate in a counterclockwise direction. The first magnetic rotor 102 and the second magnetic rotor 114 may be configured to rotate at a same speed. The coil rotor 108 may be configured to rotate at the same speed or at a different speed as the first magnetic rotor 102 and the second magnetic rotor 114, in an opposing direction. The middle rotor may rotate freely (e.g., independently) with respect to the first magnetic rotor 102 and the second magnetic rotor 114. In the first implementation of the tri-rotor generator 100, the inner magnets 106 and the outer magnets 118 may generate a magnetic field (e.g., magnetic flux lines) in a direction that is substantially perpendicular to the shaft 104 (e.g., an axis of rotation).

In the first implementation of the tri-rotor generator 100, the coil rotor 108 may include teeth 120 wrapped around an outer surface of the coil rotor 108. The teeth 120 may be located between the first portion 108A and the second portion 108B. The teeth 120 may be connected to, for example, a timing pulley, a spur gear, a V-belt, or the like that is used to rotate the coil rotor 108 using a second motor. Accordingly, the first magnetic rotor 102 and the second magnetic rotor 114 may be driven in the first direction by the first motor, and the coil rotor 108 may be driven in the second direction by the second motor. In another example, the coil rotor 108 may be driven by (e.g., rotationally connected to) at least one gear rotationally connected to the shaft 104 or the first motor. The at least one gear may reverse a rotational direction of the shaft 104 as applied to the coil rotor 108 such that the shaft 104 rotates in the first direction and the coil rotor 108 rotates in the second direction. The tri-rotor generator 100 may be driven by a single motor, that is, the first magnetic rotor 102, the coil rotor 108, and the second magnetic rotor 114 may be rotationally connected to a motor.

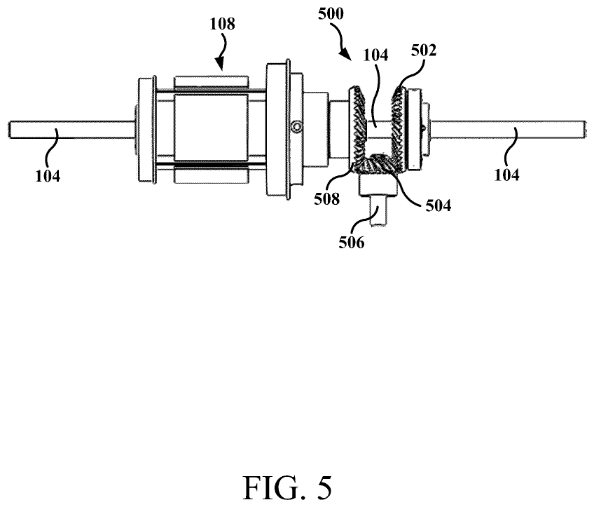

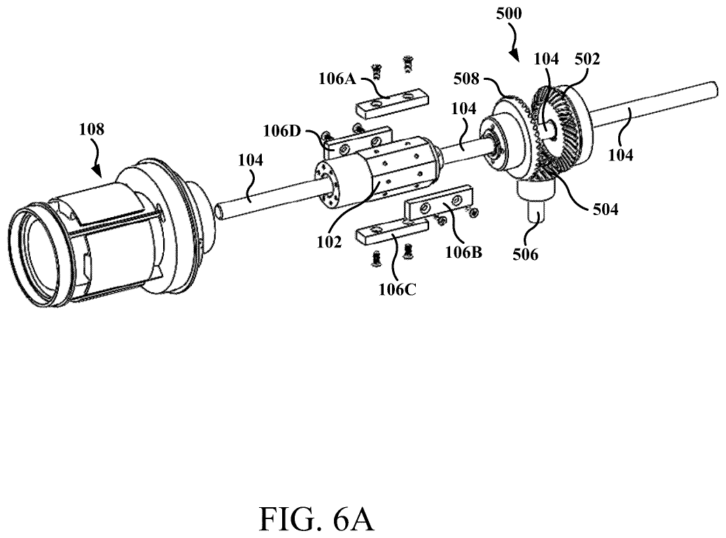

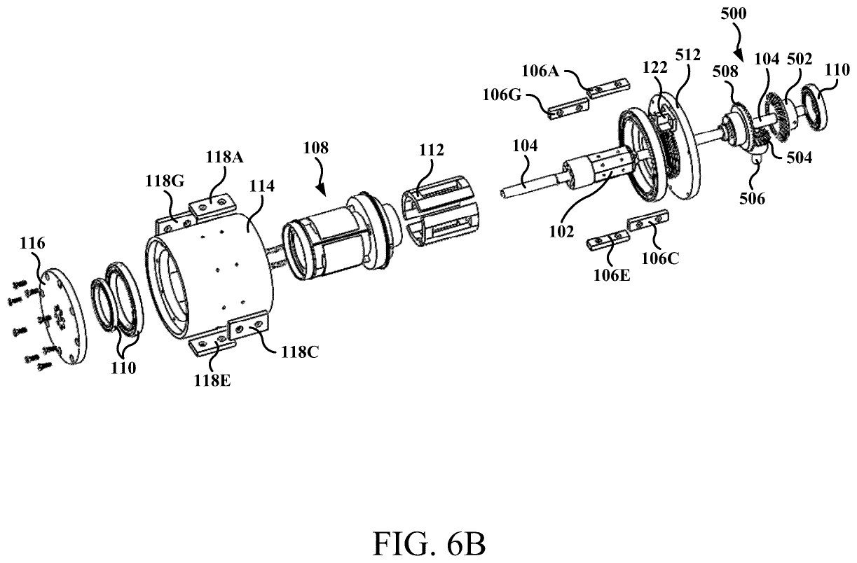

Referring to FIGS. 5, 6A, and 6B, the first magnetic rotor 102, the coil rotor 108, and the second magnetic rotor 114 may be rotationally connected to the motor through a gear box 500. The gear box 500 may be built into the tri-rotor generator 100 or may be an external gear box. The gear box 500 may allow the first magnetic rotor 102, the coil rotor 108, and the second magnetic rotor 114 to be rotationally connected to a single motor. The gear box 500 may be configured to reverse the direction of rotation of the coil rotor 108 relative to the first magnetic rotor 102 and the second magnetic rotor 114. For example, the shaft 104 may extend through the gear box 500 and be rotationally connected to the first magnetic rotor 102 and the second magnetic rotor 114. The coil rotor 108 may include one or more bearings 110 such that the coil rotor 108 may rotate freely (e.g., independently) with respect to the shaft 104, the first magnetic rotor 102, and/or the second magnetic rotor 114. The gear box 500 may include internal gearing that receives the rotational input from the shaft 104 and produces an opposing rotational output for the coil rotor 108. In an example, as shown in FIGS. 5, 6A, and 6B, the gear box 500 may be a spiral bevel gear. In other examples, the gear box 500 may be a planetary gear assembly, a worm gear system, a crossed helical gear set, a compound gear train configured to achieve the desired speed and direction of rotation, or the like. The gear box 500 may be designed to optimize torque distribution and phase synchronization.

The gear box 500 may include a drive gear 502, an idler gear 504, an idler shaft 506, and an output gear 508. The drive gear 502 may be mounted to the shaft 104 and configured to rotate with the shaft 104. The drive gear 502 may engage the idler gear 504, which may be mounted to the idler shaft 506. The idler gear 504 may reverse the direction of rotation and transfer torque to the output gear 508. The output gear 508 may be rotationally connected to the coil rotor 108. The drive gear 502, idler gear 504, and output gear 508 may be spiral bevel gears configured to transfer torque between intersecting shafts. The drive gear 502 may include one or more bearings 110 such that the drive gear 502 may rotate freely (e.g., independently) with respect to a housing of the tri-rotor generator 100. The gear box 500 may enable the coil rotor 108 to rotate in a direction opposite to the first magnetic rotor 102 and the second magnetic rotor 114 with one motor connected to the shaft 104.

The gear box 500 may be configured to selectively modify which of the first magnetic rotor 102, the coil rotor 108, and the second magnetic rotor 114 are rotationally connected to the motor. The gear box 500 may rotationally connect all or a subset of the first magnetic rotor 102, the coil rotor 108, and the second magnetic rotor 114 to the motor. For example, during periods of high (e.g., increased) load demand, the gear box 500 may operate in a full mode such that the first magnetic rotor 102, the coil rotor 108, and the second magnetic rotor 114 are all rotationally connected to the motor. In another example, during periods of low (e.g., reduced) load demand, the gear box 500 may operate in a reduced mode such that one or more of the first magnetic rotor 102, the coil rotor 108, and the second magnetic rotor 114 are not rotationally connected to the motor. The gear box 500 may be configured such that, during the reduced mode, only the first magnetic rotor 102, only the coil rotor 108, only the second magnetic rotor 114, or both the first magnetic rotor 102 and the second magnetic rotor 114 are rotationally connected to the motor. During the reduced mode, a rotor not rotationally connected to the motor may be stationary.

The gear box 500 may include multiple reduced modes corresponding to rotationally connecting different rotors to the motor. For example, a first reduced mode may correspond to only the coil rotor 108 rotationally connected to the motor, and a second reduced mode may correspond to both the first magnetic rotor 102 and the second magnetic rotor 114 (but not the coil rotor 108) rotationally connected to the motor. The gear box 500 may include a lever (e.g., a switch) configured to modify a number of rotors that are rotationally connected to the motor (e.g., switch between a full mode and any reduced modes).

Referring to FIGS. 1 to 6B, rotating the first magnetic rotor 102 and the second magnetic rotor 114 in the first direction and the coil rotor 108 in the second direction may cause the magnetic fields generated by the inner magnets 106 and the outer magnets 118 to sweep across the coils 112. The changing magnetic field induces current in the coils 112 that is transmitted by the wires to the conductive rings 109 around the second portion 108B of the coil rotor 108. A brush assembly 122 may be positioned to maintain electrical contact with the conductive rings 109. The brush assembly 122 may include one or more brushes 124 for collecting and transmitting the current to an external circuit or power management system. The brush assembly 122 may be secured using, for example, a brush plate 512. The brush plate 512 may be configured to remain stationary about the shaft 104 during rotation of the shaft 104. The brush plate 512 may maintain a position of the brush assembly 122 (and any brushes 124) with respect to the conductive rings 109.

The coils 112 may be separated into multiple phases of alternating current. For example, the coils 112 may be separated into two or more phases, each with an equal number of coils 112. The coils 112 may alternate phase around the first portion 108A. In an example where there are four coils 112, the coils 112 may be split into a first phase of two coils 112 and a second phase of two coils 112. For example, a first coil 112A and a third coil 112C may be associated with the first phase, and a second coil 112B and a fourth coil 112D may be associated with the second phase. In another example where there are eight coils 112, the coils 112 may be split into a first phase of four coils 112 and a second phase of four coils 112. For example, a first coil 112A, a third coil 112C, a fifth coil 112E, and a seventh coil 112G may be associated with the first phase, and a second coil 112B, a fourth coil 112D, a sixth coil 112F, and an eighth coil 112H may be associated with the second phase. A higher output frequency of the tri-rotor generator 100 may be obtained by adding additional coils 112, by adding additional magnets (e.g., the inner magnets 106 or the outer magnets 118), or by adding both additional coils 112 and additional magnets.

In an example where there are eight coils 112, each of the two phases may have two wires (i.e., four wires total). The two wires may be connected to the coils 112 associated with that phase, either in series or parallel (e.g., the coils 112 associated with that phase may terminate in a first wire and a second wire). For example, for maximum voltage, the two wires associated with the first phase are electrically connected to the first phase of four coils 112 in series, and the two wires associated with the second phase are electrically connected to the second phase of four coils 112 in series. In another example, for maximum current, the two wires associated with the first phase are electrically connected to the first phase of four coils 112 in parallel, and the two wires associated with the second phase are electrically connected to the second phase of four coils 112 in parallel. Each of the four wires may be connected to a conductive ring 109 (i.e., four conductive rings 109 total) on the outer surface of the second portion 108B. Each of the four conductive rings 109 may be electrically connected to a brush 124. Accordingly, each of the four wires may be electrically connected to a brush 124. In embodiments with three or more phases, the number of coils 112, wires, conductive rings 109, and brushes 124 may increase or decrease to accommodate the desired number of phases.

The coils 112 may be separated into one or more phases (e.g., single-phase, two-phase, three-phase). The coils 112 may be arranged in different configurations, for example, the coils 112 may be electrically arranged in a delta or Y (wye) configuration. The configuration of the coils 112 may increase or decrease a required number of components of the tri-rotor generator 100. The configuration of the coils 112 may increase or decrease the number of conductive rings 109. For example, in a three-phase delta configuration, three conductive rings 109 may be used, each conductive ring 109 corresponding to one terminal of a closed-loop winding arrangement. In another example, in a three-phase Y configuration, four conductive rings 109 may be used (e.g., one conductive ring 109 for each of the three phase outputs and one conductive ring 109 for the shared neutral connection).

The tri-rotor generator 100 may further include a clamp 126 surrounding the shaft 104. The clamp 126 may hold the first magnetic rotor 102, the coil rotor 108, and the second magnetic rotor 114 in place along the shaft 104.

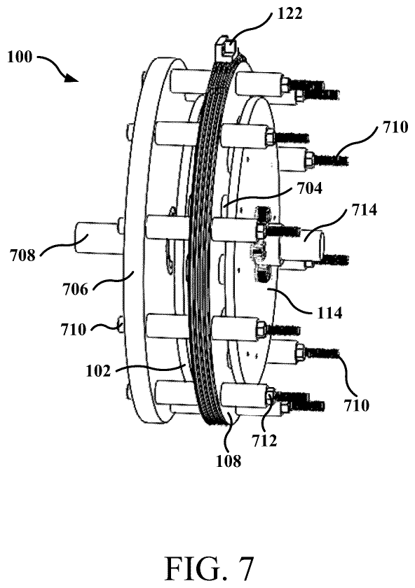

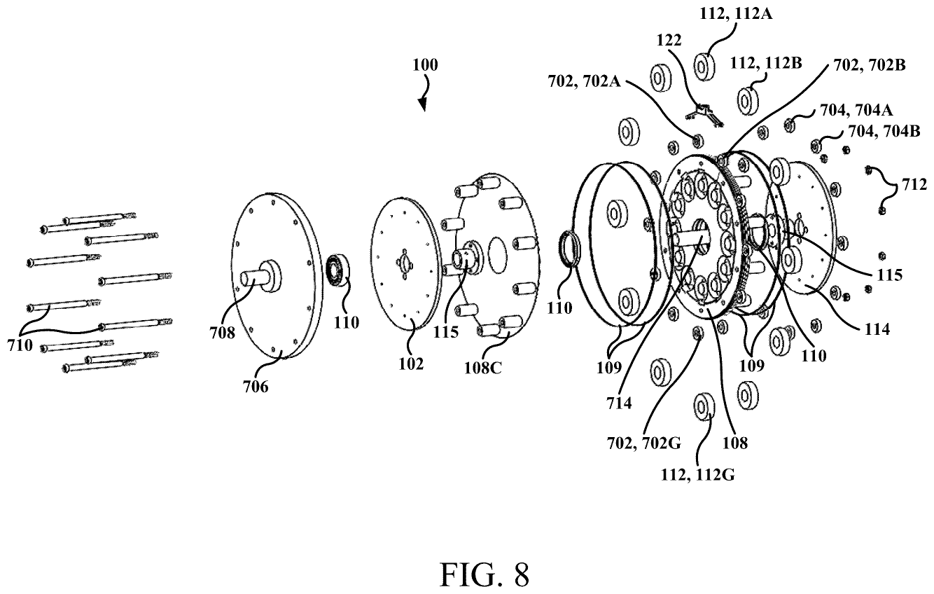

Referring to FIGS. 7 to 10, a second implementation (e.g., an axial configuration) of the tri-rotor generator 100 is shown. The tri-rotor generator 100 may include a case (e.g., a housing, container, cover, or the like) containing components of the tri-rotor generator 100. For ease of understanding, the case is omitted from FIGS. 7 to 10. In the second implementation of the tri-rotor generator 100, the coil rotor 108 may be, for example, a middle rotor. The coil rotor 108 may be made from, for example, plastic or metal (e.g., stamped metal pieces). The coil rotor 108 may include one or more coils 112. In an example, there may be twelve coils 112. The coils 112 may be coils of conductive wire (e.g., copper) in which an electric current may be induced. For example, the coils 112 may be enclosed in the coil rotor 108. The coil rotor 108 may be made from more than one piece. For example, a first piece of the coil rotor 108 may include recessed areas to contain the coils 112, and a second piece of the coil rotor 108 may secure the coils 112 in the recessed areas (e.g., by covering a surface of the first piece of the coil rotor 108 such that the coils 112 are contained between the first piece and the second piece of the coil rotor 108). The coil rotor 108 may include wires connected to the coils 112. The wires may electrically connect the coils 112 to conductive rings 109 around the coil rotor 108. In an example, there may be twelve coils 112 connected to four conductive rings 109 around the second portion 108B, that is, two conductive rings 109 may be electrically connected to six of the twelve coils 112 and the other two conductive rings 109 may be connected to the other six of the twelve coils 112.

In the second implementation of the tri-rotor generator 100, the first magnetic rotor 102 may be, for example, a first side rotor. The first magnetic rotor 102 may be made from metal, for example, steel. The first magnetic rotor 102 may include one or more first side magnets 702. The first side magnets 702 may be located on a side surface of the first magnetic rotor 102. The first side magnets 702 may be magnetic field sources. For example, the first side magnets 702 may be permanent magnets. In another example, the first side magnets 702 may be electromagnets. The first side magnets 702 may be arranged to alternate polarity around the first magnetic rotor 102. For example, a first first side magnet 702A may be a first polarity, a second first side magnet 702B may be a second polarity, a third first side magnet 702C may be the first polarity, and a fourth first side magnet 702D may be the second polarity.

In the second implementation of the tri-rotor generator 100, the second magnetic rotor 114 may be, for example, a second side rotor. The second magnetic rotor 114 may be made from metal, for example, steel. The second magnetic rotor 114 and the first magnetic rotor 102 may be configured to rotate in a same direction. In an example, the second magnetic rotor 114 and the first magnetic rotor 102 may be configured to rotate synchronically. The second magnetic rotor 114 may include one or more second side magnets 704. The second side magnets 704 may be located on a side surface of the second magnetic rotor 114. The second side magnets 704 may be magnetic field sources. For example, the second side magnets 704 may be permanent magnets. In another example, the second side magnets 704 may be electromagnets. The second side magnets 704 may be arranged to alternate polarity around the second magnetic rotor 114. For example, a first second side magnet 704A may be a first polarity, a second second side magnet 704B may be a second polarity, a third second side magnet 704C may be the first polarity, and a fourth second side magnet 704D may be the second polarity. In the second implementation of the tri-rotor generator 100, the first side magnets 702 and the second side magnets 704 may generate a magnetic field (e.g., magnetic flux lines) in a direction that is substantially parallel to the axis of rotation.

The coil rotor 108 may be disposed between the first magnetic rotor 102 and the second magnetic rotor 114. The coil rotor 108 may be positioned such that it is located within a magnetic field generated by the first side magnets 702 and the second side magnets 704. The first magnetic rotor 102, the coil rotor 108, and the second magnetic rotor 114 may be arranged sequentially along a common axis (e.g., a central rotational axis). The first magnetic rotor 102 may be positioned such that the first side magnets 702 are located adjacent to one side of the coil rotor 108. The second magnetic rotor 114 may be positioned such that the second side magnets 704 are located adjacent to the opposite side of the coil rotor 108. This positioning allows the opposing magnetic fields from the first magnetic rotor 102 and the second magnetic rotor 114 to interact across the coils 112 of the coil rotor 108. The coil rotor 108 may include one or more bearings 110 such that the coil rotor 108 may rotate freely (e.g., independently) with respect to the first magnetic rotor 102 and/or the second magnetic rotor 114.

The second implementation of the tri-rotor generator 100 may include an interface disk 706. The interface disk 706 may include or support a first shaft 708 and may be mechanically connected to the coil rotor 108. The interface disk 706 may at least partially cover or enclose the first magnetic rotor 102. The first magnetic rotor 102 may be positioned (e.g., disposed) between the interface disk 706 and the coil rotor 108. The interface disk 706 may be secured to the coil rotor 108 using fasteners, for example, bolts 710 and nuts 712. The coil rotor 108 may further include a coil rotor plate 108C. The coil rotor plate 108C may be removable. The coil rotor plate 108C may be removed to allow for placement or replacement of the coils 112 within the coil rotor 108. The coil rotor plate 108C may be attached to the coil rotor 108 using the bolts 710.

The second implementation of the tri-rotor generator 100 may include a second shaft 714. The second shaft 714 may be rotationally connected to the first magnetic rotor 102 and the second magnetic rotor 114. The first magnetic rotor 102 and the second magnetic rotor 114 may each be rotationally connected to the second shaft 714 using a shaft collar 115 or other mechanical coupling. The first shaft 708 may be rotationally connected to the coil rotor 108. The first shaft 708 may be an input shaft driven by, for example, a wind turbine or vehicle engine. Rotating the first shaft 708 and the second shaft 714 may enable counter-rotation of the first magnetic rotor 102 and the second magnetic rotor 114 with respect to the coil rotor 108. For example, a first motor may be connected to the first shaft 708 and may be configured to rotate the coil rotor 108 in a first direction, while a second motor may be connected to the second shaft 714 and configured to rotate the first magnetic rotor 102 and the second magnetic rotor 114 in a second, opposite direction. The first shaft 708 and the second shaft 714 may be supported by bearings 110 or bushings to reduce friction and facilitate stable rotation. The first motor and the second motor may be independently controlled based on desired rotational speeds, phase relationships, or power outputs.

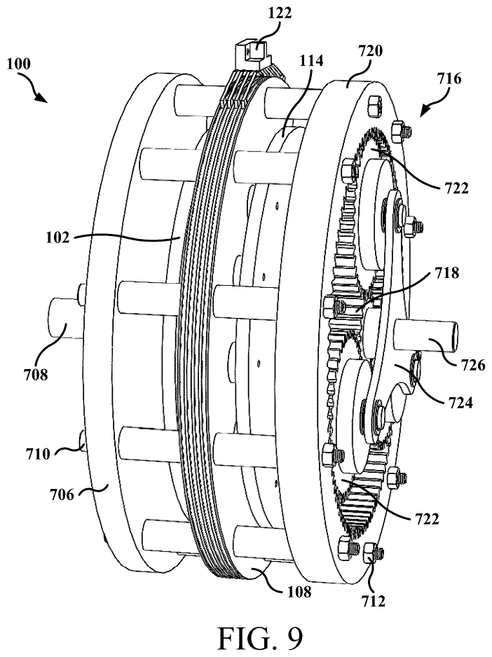

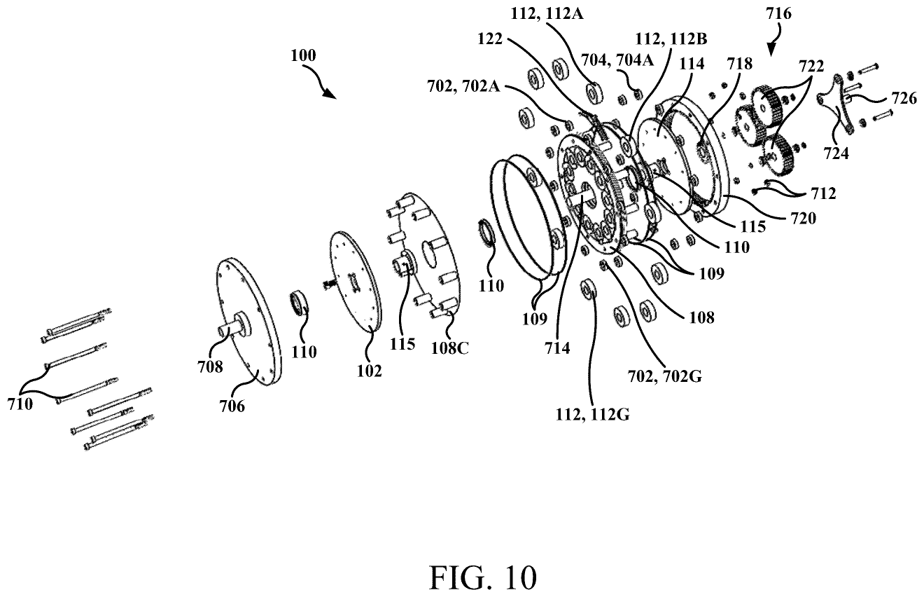

The first magnetic rotor 102, the coil rotor 108, and the second magnetic rotor 114 may be rotationally connected to a gear box 500. The gear box 500 may be built into the tri-rotor generator 100 or may be an external gear box. The gear box 500 may allow the first magnetic rotor 102, the coil rotor 108, and the second magnetic rotor 114 to be rotationally connected to a single motor. The gear box 500 may be configured to reverse the direction of rotation of the coil rotor 108 relative to the first magnetic rotor 102 and the second magnetic rotor 114. For example, the gear box 500 may include internal gearing that receives the rotational input from the first shaft 708 and produces an opposing rotational output for the first magnetic rotor 102 and the second magnetic rotor 114. In an example, as shown in FIGS. 9 and 10, the gear box 500 may be a planetary gear assembly 716. In other examples, the gear box 500 may be a spiral bevel gear, a worm gear system, a crossed helical gear set, a compound gear train configured to achieve the desired speed and direction of rotation, or the like. The gear box 500 may be designed to optimize torque distribution and phase synchronization.

The gear box 500 may be configured to selectively modify which of the first magnetic rotor 102, the coil rotor 108, and the second magnetic rotor 114 are rotationally connected to the motor. The gear box 500 may rotationally connect all or a subset of the first magnetic rotor 102, the coil rotor 108, and the second magnetic rotor 114 to the motor. For example, during periods of high (e.g., increased) load demand, the gear box 500 may operate in a full mode such that the first magnetic rotor 102, the coil rotor 108, and the second magnetic rotor 114 are all rotationally connected to the motor. In another example, during periods of low (e.g., reduced) load demand, the gear box 500 may operate in a reduced mode such that one or more of the first magnetic rotor 102, the coil rotor 108, and the second magnetic rotor 114 are not rotationally connected to the motor. The gear box 500 may be configured such that, during the reduced mode, only the first magnetic rotor 102, only the coil rotor 108, only the second magnetic rotor 114, or both the first magnetic rotor 102 and the second magnetic rotor 114 are rotationally connected to the motor. During the reduced mode, a rotor not rotationally connected to the motor may be stationary.

The gear box 500 may include multiple reduced modes corresponding to rotationally connecting different rotors to the motor. For example, a first reduced mode may correspond to only the coil rotor 108 rotationally connected to the motor, and a second reduced mode may correspond to both the first magnetic rotor 102 and the second magnetic rotor 114 (but not the coil rotor 108) rotationally connected to the motor. The gear box 500 may include a lever (e.g., a switch) configured to modify a number of rotors that are rotationally connected to the motor (e.g., switch between a full mode and any reduced modes).

Referring to FIGS. 9 and 10, the second implementation of the tri-rotor generator 100 including the planetary gear assembly 716 is shown. The planetary gear assembly 716 may be located along the common axis of the tri-rotor generator 100. The planetary gear assembly 716 may be positioned on a side of the tri-rotor generator 100 and may be mechanically integrated with the first magnetic rotor 102, the coil rotor 108, and the second magnetic rotor 114. The planetary gear assembly 716 may comprise a sun gear 718, a ring gear 720, and one or more planetary gears 722 (e.g., three planetary gears). The second shaft 714 may be rotationally connected to the sun gear 718. The planetary gear assembly 716 may further include a planet carrier 724 connected to the planetary gears 722. The planet carrier 724 may include a third shaft 726. The planetary gear assembly 716 may operate by transferring torque between the ring gear 720 and the sun gear 718 through the planetary gears 722, which are supported by the planet carrier 724. The planetary gear assembly 716 may enable counter-rotation of the ring gear 720 and the sun gear 718.

The ring gear 720 may be rotationally connected to the first shaft 708 and the coil rotor 108. For example, the ring gear 720 may be secured to the coil rotor 108 using the bolts 710. Rotation of the ring gear 720 may enable counter-rotation of the coil rotor 108 with respect to the first magnetic rotor 102 and the second magnetic rotor 114. In an example, the ring gear 720 may be rotated by rotating the first shaft 708. In other examples, the ring gear 720 may be rotated using a timing pulley, a spur gear, a V-belt, or the like. Rotating the ring gear 720 in a first direction may cause the coil rotor 108 to rotate in the first direction and the sun gear 718 to rotate in a second, opposite direction. Rotating the sun gear 718 in the second direction may cause the second shaft 714, the first magnetic rotor 102, and the second magnetic rotor 114 to rotate in the second direction. Accordingly, using the planetary gear assembly 716, a single motor may be used to rotate the first magnetic rotor 102, the second magnetic rotor 114, and the coil rotor 108.

The sun gear 718 and the ring gear 720 may be configured to rotate in opposite directions. In some examples, the first magnetic rotor 102 and the second magnetic rotor 114 may be rotationally connected to the sun gear 718, and the coil rotor 108 may be rotationally connected to the ring gear 720. Alternatively, in other examples, the first magnetic rotor 102 and the second magnetic rotor 114 may be rotationally connected to the ring gear 720, and the coil rotor 108 may be rotationally connected to the sun gear 718.

In an example (shown in FIGS. 9 and 10), the coil rotor 108 may be rotationally connected to the ring gear 720, and the first magnetic rotor 102 and the second magnetic rotor 114 may be rotationally connected to the sun gear 718. The first shaft 708 may be rotationally connected to the interface disk 706 (e.g., to the coil rotor 108) and used to drive the ring gear 720. The first shaft 708 may be configured to rotate (e.g., drive) the coil rotor 108 and the ring gear 720 (e.g., in a first direction). The first shaft 708 may be connected to a rotation source, for example, blades of a wind turbine. The second shaft 714 may be rotationally connected to the first magnetic rotor 102 and the second magnetic rotor 114. The third shaft 726 may be connected to the planet carrier 724. Rotation of the first shaft causes the ring gear 720 and the coil rotor 108 to rotate in a first direction, which causes the sun gear 718, to rotate in a second direction opposite the first direction. Rotation of the sun gear 718 in the second direction causes the first magnetic rotor 102 and the second magnetic rotor 114 to rotate in the second direction. In some examples, the first shaft 708 may be omitted, and the ring gear 720 may be rotationally connected to a rotation source through, for example, pulleys, gears, or the like.

The planetary gear assembly 716 may operate as a continuously variable transmission (CVT). For example, the planetary gear assembly 716 may function as an electronically-controlled continuously variable transmission (E-CVT). The third shaft 726 may be used to drive the planet carrier 724. The E-CVT may allow dynamic control of the rotational relationship between the sun gear 718 and the ring gear 720 by adjusting the rotational input to the planet carrier 724. By modulating the speed of the third shaft 726, the rotational speed of the coil rotor 108 relative to the first magnetic rotor 102 and the second magnetic rotor 114 may be controlled. Controlling the rotational speed of the planet carrier 724 may enable the tri-rotor generator 100 to maintain a consistent relative rotational speed between the coil rotor 108 and the magnetic rotors (e.g., the first magnetic rotor 102 and the second magnetic rotor 114), thereby producing a stable electrical output frequency. The speed of the third shaft 726 may be controlled based on an input speed (e.g., the speed of the first shaft 708), i.e., a motor rotationally connected to the third shaft 726 may be configured to rotate the third shaft 726 in response to changes in rotation of the first shaft 708. The E-CVT may allow the tri-rotor generator 100 to generate electricity at a standard frequency (e.g., 50 Hz, 60 Hz, or the like) regardless of variations in mechanical input speed (e.g., rotation of the first shaft 708). The E-CVT may facilitate connecting the tri-rotor generator 100 directly to an electrical grid or for applications that require frequency-stable power output.

Rotating the first magnetic rotor 102 and the second magnetic rotor 114 in a first direction and the coil rotor 108 in a second, opposite direction may cause the magnetic fields generated by the first side magnets 702 and the second side magnets 704 to sweep axially across the coils 112 of the coil rotor 108. The changing magnetic field may induce an electric current in the coils 112. The induced current may be transmitted by electrical wires to conductive rings 109 located around the coil rotor 108. A brush assembly 122 may be positioned to maintain electrical contact with the conductive rings 109. The brush assembly 122 may include at least one brush 124 for collecting and transmitting the current to an external circuit or power management system.

The coils 112 may be separated into multiple phases of alternating current. For example, the coils 112 may be separated into two or more phases, each with an equal number of coils 112. In an example where there are twelve coils 112, the coils 112 may be split into a first phase of six coils 112 and a second phase of six coils 112. The coils 112 may alternate phase around the coil rotor 108. For example, a first coil 112A, a third coil 112C, a fifth coil 112E, a seventh coil 112G, a ninth coil 112I, and an eleventh coil 112K may be associated with the first phase, and a second coil 112B, a fourth coil 112D, a sixth coil 112F, an eighth coil 112H, a tenth coil 112J, and a twelfth coil 112L may be associated with the second phase. A higher output frequency of the tri-rotor generator 100 may be obtained by adding additional coils 112, by adding additional magnets (e.g., the first side magnets 702 or the second side magnets 704), or by adding both additional coils 112 and additional magnets.

In another example where there are twelve coils 112, the coils 112 may be separated into three phases. Each of the three phases may include four coils 112. The coils 112 may alternate by phase around the coil rotor 108. For example, a first coil 112A, a fourth coil 112D, a seventh coil 112G, and a tenth coil 112J may be associated with the first phase, a second coil 112B, a fifth coil 112E, an eighth coil 112H, and an eleventh coil 112K may be associated with the second phase, and a third coil 112C, a sixth coil 112F, a ninth coil 112I, and a twelfth coil 112L may be associated with the third phase.

The coils 112 may be separated into one or more phases (e.g., single-phase, two-phase, three-phase). The coils 112 may be arranged in different configurations, for example, the coils 112 may be electrically arranged in a delta or Y (wye) configuration. The configuration of the coils 112 may increase or decrease a required number of components of the tri-rotor generator 100. The configuration of the coils 112 may increase or decrease the number of conductive rings 109. For example, in a three-phase delta configuration, three conductive rings 109 may be used, each conductive ring 109 corresponding to one terminal of a closed-loop winding arrangement. In another example, in a three-phase Y configuration, four conductive rings 109 may be used (e.g., one conductive ring 109 for each of the three phase outputs and one conductive ring 109 for the shared neutral connection).

Each phase may be associated with two wires (i.e., four wires total in a two-phase configuration, or six wires total in a three-phase configuration). The wires may be electrically connected to conductive rings 109 around the coil rotor 108. Each wire may be electrically connected to a respective conductive ring 109. Each conductive ring 109 may be electrically connected to a respective brush 124. Accordingly, each of the wires may be electrically connected to a brush 124. In embodiments with a different number of phases, the number of coils 112, wires, conductive rings 109, and brushes 124 may increase or decrease to accommodate the desired number of phases.

In the second implementation of the tri-rotor generator 100, the power output may be increased by adding one or more additional magnetic rotors and one or more additional coil rotors. The additional rotors may be added along the axis of rotation. In an example where the first magnetic rotor 102 and the second magnetic rotor 114 are rotationally connected to the second shaft 714, any additional magnetic rotors may be rotationally connected to the second shaft 714. In an example where the coil rotor 108 is rotationally connected to the first shaft 708 (e.g., through the interface disk 706), any additional coil rotors may be rotationally connected to the first shaft 708. A magnetic rotor between two coil rotors may be configured to have magnets on both sides. The additional rotors may be added such that every coil rotor has a magnetic rotor on each side. For example, a generator containing five rotors may include a first magnetic rotor, a second magnetic rotor, a third magnetic rotor, a first coil rotor disposed between the first magnetic rotor and the second magnetic rotor, and a second coil rotor disposed between the second magnetic rotor and the third magnetic rotor. The second magnetic rotor may include magnets adjacent to the first coil rotor and magnets adjacent to the second coil rotor. In another example, a generator containing six rotors may include a first magnetic rotor, a second magnetic rotor, a third magnetic rotor, a fourth magnetic rotor, a first coil rotor disposed between the first magnetic rotor and the second magnetic rotor, and a second coil rotor disposed between the third magnetic rotor and the fourth magnetic rotor. Any number of additional magnetic rotors and additional coil rotors may be added to increase the power output of the generator without significant increases in a diameter of the generator.

The tri-rotor generator 100 may be employed in a variety of applications. For example, the tri-rotor generator 100 may be used as a vehicle alternator (e.g., in automobiles, trucks, or buses) or as an aircraft alternator (e.g., in planes, helicopters, or drones). The tri-rotor generator 100 may be implemented in systems using single-phase or multi-phase configurations. In an example, the tri-rotor generator 100 may be used in AC to DC power conversion systems (e.g., for battery charging or onboard power electronics). In another example, the tri-rotor generator may be incorporated into water energy systems (e.g., water wheels), wind energy systems (e.g., wind turbines), or the like, including wind turbines with single blades, dual blades, or other blade configurations.

The first implementation of the tri-rotor generator 100 (e.g., the radial configuration) may be particularly suitable for high-speed applications, such as use with internal combustion engines, where low to mid-range power output is desired. For example, the radial configuration may be well-suited for vehicle or aircraft alternators that operate at relatively high shaft speeds. The radial configuration may support single-phase or multi-phase operation and may be adapted for either AC or AC-to-DC output.

The second implementation of the tri-rotor generator (e.g., the axial configuration) may be particularly suited for low-speed applications where higher power output is required, such as wind energy harvesting. For example, the axial configuration may be used in horizontal or vertical axis wind turbines with one or more blades, and may be configured for one or more phase (e.g., single-phase, two-phase, three-phase, or the like) AC output. In some implementations, the axial configuration may also be adapted for use in grid-tied systems, where constant frequency output is required for direct electrical grid integration.

Example A is a tri-rotor generator including a first magnetic rotor with one or more magnetic field sources, a second magnetic rotor with one or more magnetic field sources, and a coil rotor with two or more electrical coils, wherein the coil rotor is disposed between the first magnetic rotor and the second magnetic rotor.

Example B is the tri-rotor generator of example A, further including a shaft, wherein the first magnetic rotor and the second magnetic rotor are rotationally connected to the shaft.

Example C is the tri-rotor generator of example A, wherein each of the one or more magnetic field sources is a permanent magnet or an electromagnet.

Example D is the tri-rotor generator of example A, wherein the first magnetic rotor, the second magnetic rotor, and the coil rotor are rotationally connected to a motor through a gear box.

Example E is the tri-rotor generator of example D, wherein the gear box is a planetary gear assembly, the planetary gear assembly including a sun gear rotationally connected to the first magnetic rotor and the second magnetic rotor, and a ring gear rotationally connected to the coil rotor.

Example F is the tri-rotor generator of example E, further including a first shaft rotationally connected to the sun gear, wherein rotation of the first shaft causes the first magnetic rotor and the second magnetic rotor to rotate in a first direction and causes the coil rotor to rotate in a second direction, and a second shaft rotationally connected to a planet carrier of the planetary gear assembly.

Example G is the tri-rotor generator of example A, wherein the two or more electrical coils include four coils associated with a first phase and four coils associated with a second phase, the four coils associated with the first phase are connected in series and terminate in a first wire and a second wire, and the four coils associated with the second phase are connected in series and terminate in a third wire and a fourth wire.

Example H is the tri-rotor generator of example G, further including a first brush electrically connected to the first wire, a second brush electrically connected to the second wire, a third brush electrically connected to the third wire, and a fourth brush electrically connected to the fourth wire.

Example I is a tri-rotor generator including a first magnetic rotor rotationally connected to a sun gear of a planetary gear assembly, a second magnetic rotor rotationally connected to the sun gear, a coil rotor rotationally connected to a ring gear of the planetary gear assembly, wherein the coil rotor is disposed between the first magnetic rotor and the second magnetic rotor, and a first shaft rotationally connected to the ring gear, wherein rotation of the first shaft causes the ring gear and the coil rotor to rotate in a first direction and causes the sun gear, the first magnetic rotor, and the second magnetic rotor to rotate in a second direction.

Example J is the tri-rotor generator of example I, further including a second shaft rotationally connected to a planet carrier of the planetary gear assembly, and a motor rotationally connected to the second shaft.

Example K is the tri-rotor generator of example J, wherein the motor is configured to control rotation of the sun gear and the ring gear to maintain a constant electrical output frequency.

Example L is the tri-rotor generator of example K, wherein the motor is configured to rotate the second shaft in response to changes in rotation of the first shaft.

Example M is the tri-rotor generator of example I, wherein the first magnetic rotor, the second magnetic rotor, and the coil rotor are arranged in an axial direction of the first shaft.

Example N is a tri-rotor generator including an inner rotor rotationally connected to a shaft, a middle rotor with two or more coils, wherein a first portion of the middle rotor at least partially surrounds at least a portion of the inner rotor and a second portion of the middle rotor extends beyond the inner rotor in an axial direction, and an outer rotor, wherein the outer rotor at least partially surrounds the first portion of the middle rotor, and the outer rotor and the inner rotor each include one or more magnetic field sources.

Example O is the tri-rotor generator of example N, wherein the outer rotor is rotationally connected to the shaft.

Example P is the tri-rotor generator of example N, wherein the outer rotor is rotationally connected to the inner rotor such that the outer rotor rotates synchronically and in a same direction as the inner rotor.

Example Q is the tri-rotor generator of example N, wherein the middle rotor is rotationally connected to at least one gear rotationally connected to the shaft.

Example R is the tri-rotor generator of example N, wherein the inner rotor, the middle rotor, and the outer rotor are rotationally connected to a motor through a gear box.

Example S is the tri-rotor generator of example R, wherein the gear box includes bevel gears.

Example T is the tri-rotor generator of example R, wherein the gear box includes a full mode wherein the inner rotor, the middle rotor, and the outer rotor are rotationally connected to the motor and a reduced mode wherein one or more of the inner rotor, the middle rotor, and the outer rotor are not rotationally connected to the motor.

Example U is the tri-rotor generator of example N, wherein the two or more coils are electrically connected to brushes on the second portion of the middle rotor.

Example V is the tri-rotor generator of example N, wherein each of the one or more magnetic field sources is a permanent magnet.

Example W is the tri-rotor generator of example N, wherein each of the one or more magnetic field sources is an electromagnet.

Example X is the tri-rotor generator of example N, wherein the inner rotor includes eight magnetic field sources and the outer rotor includes eight magnetic field sources.

Example Y is the tri-rotor generator of example N, wherein the middle rotor rotates independently with respect to the inner rotor and the outer rotor.

Example Z is the tri-rotor generator of example N, wherein the shaft is rotationally connected to a first motor and the middle rotor is rotationally connected to a second motor.

Example AA is the tri-rotor generator of example Z, wherein the middle rotor is rotationally connected to a timing pulley, a spur gear, or a V-belt.

Example AB is the tri-rotor generator of example N, wherein the inner rotor is rotatable in a first direction, the middle rotor is rotatable in a second direction, and the outer rotor is rotatable in the first direction.

Example AC is the tri-rotor generator of example N, wherein the two or more coils include eight coils.

Example AD is the tri-rotor generator of example N, wherein the two or more coils are separated into two phases.

Example AE is the tri-rotor generator of example N, wherein the two or more coils include four coils associated with a first phase and four coils associated with a second phase, the four coils associated with the first phase comprise a first wire containing two coils and a second wire containing two coils, and the four coils associated with the second phase includes a third wire containing two coils and a fourth wire containing two coils.

Example AF is the tri-rotor generator of example AE, further including a first brush electrically connected to the first wire, a second brush electrically connected to the second wire, a third brush electrically connected to the third wire, and a fourth brush electrically connected to the fourth wire.

Example AG is the tri-rotor generator of example N, wherein the two or more coils include four coils.

What is claimed is:

1. A generator, comprising:
a first magnetic rotor comprising one or more magnetic field sources;
a second magnetic rotor comprising one or more magnetic field sources; and
a coil rotor comprising one or more electrical coils, wherein the coil rotor is disposed between the first magnetic rotor and the second magnetic rotor.

2. The generator of claim 1, further comprising:
a shaft, wherein the first magnetic rotor and the second magnetic rotor are rotationally connected to the shaft.

3. The generator of claim 1, wherein each of the one or more magnetic field sources is a permanent magnet or an electromagnet.

4. The generator of claim 1, wherein the first magnetic rotor, the second magnetic rotor, and the coil rotor are rotationally connected to a motor through a gear box.

5. The generator of claim 4, wherein the gear box is a planetary gear assembly, the planetary gear assembly comprising:
a sun gear rotationally connected to the first magnetic rotor and the second magnetic rotor; and
a ring gear rotationally connected to the coil rotor.

6. The generator of claim 5, further comprising:
a first shaft rotationally connected to the sun gear, wherein rotation of the first shaft causes the first magnetic rotor and the second magnetic rotor to rotate in a first direction and causes the coil rotor to rotate in a second direction; and
a second shaft rotationally connected to a planet carrier of the planetary gear assembly.

7. The generator of claim 1, wherein:
the one or more electrical coils comprise four coils associated with a first phase and four coils associated with a second phase;
the four coils associated with the first phase are connected in series and terminate in a first wire and a second wire; and
the four coils associated with the second phase are connected in series and terminate in a third wire and a fourth wire.

8. The generator of claim 7, further comprising:
a first brush electrically connected to the first wire;
a second brush electrically connected to the second wire;
a third brush electrically connected to the third wire; and
a fourth brush electrically connected to the fourth wire.

9. A generator, comprising:
a first magnetic rotor rotationally connected to a sun gear of a planetary gear assembly;
a second magnetic rotor rotationally connected to the sun gear;
a coil rotor rotationally connected to a ring gear of the planetary gear assembly, wherein the coil rotor is disposed between the first magnetic rotor and the second magnetic rotor; and
a first shaft rotationally connected to the ring gear, wherein rotation of the first shaft causes the ring gear and the coil rotor to rotate in a first direction and causes the sun gear, the first magnetic rotor, and the second magnetic rotor to rotate in a second direction.

10. The generator of claim 9, further comprising:
a second shaft rotationally connected to a planet carrier of the planetary gear assembly; and
a motor rotationally connected to the second shaft.

11. The generator of claim 10, wherein the motor is configured to control rotation of the sun gear based on a rotation of the ring gear to maintain a constant electrical output frequency.

12. The generator of claim 11, wherein the motor is configured to rotate the second shaft in response to changes in rotation of the first shaft.

13. The generator of claim 9, wherein the first magnetic rotor, the second magnetic rotor, and the coil rotor are arranged in an axial direction of the first shaft.

14. A generator, comprising:
an inner rotor rotationally connected to a shaft;
a middle rotor comprising two or more coils, wherein a first portion of the middle rotor at least partially surrounds at least a portion of the inner rotor and a second portion of the middle rotor extends beyond the inner rotor in an axial direction; and
an outer rotor, wherein the outer rotor at least partially surrounds the first portion of the middle rotor, and the outer rotor and the inner rotor each comprise one or more magnetic field sources.

15. The generator of claim 14, wherein the outer rotor is rotationally connected to the shaft.

16. The generator of claim 14, wherein the outer rotor is rotationally connected to the inner rotor such that the outer rotor rotates synchronically and in a same direction as the inner rotor.

17. The generator of claim 14, wherein the middle rotor is rotationally connected to at least one gear rotationally connected to the shaft.

18. The generator of claim 14, wherein the inner rotor, the middle rotor, and the outer rotor are rotationally connected to a motor through a gear box.

19. The generator of claim 18, wherein the gear box comprises a full mode wherein the inner rotor, the middle rotor, and the outer rotor are rotationally connected to the motor and a reduced mode wherein one or more of the inner rotor, the middle rotor, and the outer rotor are not rotationally connected to the motor.

20. The generator of claim 14, wherein the two or more coils are electrically connected to brushes on the second portion of the middle rotor.
